(19) United States
(12) Patent Application Publication
(10) Pub. No.: US 2014/0280396 A1
(43) Pub. Date: Sep. 18, 2014

(54) OPERATING METHOD FOR USER SYSTEM INCLUDING HOST AND MEMORY SYSTEM

(71) Applicant: Samsung Electronics Co., Ltd., Suwon-Si (KR)

(72) Inventors: Sang-jin OH, Suwon-si (KR); Sungchul KIM, Hwaseong-si (KR); Jong Tae PARK, Seoul (KR)

(73) Assignee: SAMSUNG ELECTRONICS CO., LTD., Suwon-Si (KR)

(21) Appl. No.: 14/204,438

(22) Filed: Mar. 11, 2014

(30) Foreign Application Priority Data
Mar. 15, 2013 (KR) 10-2013-0028055

(51) Int. Cl. G06F 17/30

(52) U.S. Cl. CPC G06F 17/30174; G06F 17/30117
USPC 707/823; 707/822

(57) ABSTRACT

An operating method of a user system having a host and a memory system, the memory system having first and second storage devices, includes deleting a first original file stored in the first storage device, using the host; generating, at the host, a comparison result by performing a comparison operation based on first delete information of the first original file and a mapping table; sending converted delete information from the host to the memory system when the comparison result indicates that a first copied file is stored in the second storage device, the first copied file being a copy of the first original file; and setting a page of the second storage device, in which the first copied file is stored, to an invalid page based on the converted delete information, using the memory system. The host recognizes the first storage device as a main device of the memory system.

### CROSS-REFERENCE TO RELATED APPLICATIONS

A claim for priority under 35 U.S.C. §119 is made to Korean Patent Application No. 10-2013-0028055 filed Mar. 15, 2013, in the Korean Intellectual Property Office, the entire contents of which are hereby incorporated by reference.

### TECHNICAL FIELD

At least some embodiments of the inventive concepts described herein relate to a memory system, and/or more particularly, relate to a host including an operating system and a device driver and/or an operating method of a user system including a memory system having first and second storage devices.

### BACKGROUND

A semiconductor memory device is a memory device which is fabricated using semiconductors such as silicon (Si), germanium (Ge), gallium arsenide (GaAs), indium phosphide (InP), and the like. Semiconductor memory devices are classified into volatile memory devices and nonvolatile memory devices.

The volatile memory devices may lose stored contents at power-off. The volatile memory devices include a static RAM (SRAM), a dynamic RAM (DRAM), a synchronous DRAM (SDRAM), and the like. The nonvolatile memory devices may retain stored contents even at power-off. The nonvolatile memory devices include a read only memory (ROM), a programmable ROM (PROM), an electrically programmable ROM (EPROM), an electrically erasable and programmable ROM (EEPROM), a flash memory device, a phase-change RAM (PRAM), a magnetic RAM (MRAM), a resistive RAM (RRAM), a ferroelectric RAM (FRAM), etc. The flash memory device has a NOR type or a NAND type.

A mass solid state drive (SSD) is provided based on a nonvolatile memory device. Due to the stability and price problems of the SSD, the SSD is used as a hybrid memory system in which a conventional HDD and the SSD are combined. In this case, the HDD is used as a main storage medium due to stability, low-price and mass-storage characteristics, and the SSD is used as a cache memory due to a high-speed characteristic. An operating system of a host recognizes a hybrid memory system using a device ID of the HDD.

### SUMMARY

One aspect of at least some example embodiments of the inventive concepts is directed to provide an operating method of a user system which includes a host and a memory system having first and second storage devices is provided. The operating method comprises allowing the host to delete a first original file stored in the first storage device; allowing the host to send converted delete information to the memory system when the comparison result indicates that a first copied file being a copy of the first original file is stored in the second storage device; and allowing the memory system to erase the first copied file stored in the second storage device based on the converted delete information. The host recognizes the first storage device as a main device of the memory system.

According to at least some example embodiments of the inventive concepts, the converted delete information comprises address information of the second storage device at which the first copied file is stored.

According to at least some example embodiments of the inventive concepts, the host accesses the memory system based on a file system of the first storage device.

According to at least some example embodiments of the inventive concepts, the allowing the host to send converted delete information to the memory system comprises allowing the host to generate delete information of the first original file when an idle time of the host exceeds a threshold time; allowing the host to generate the converted delete information based on the delete information and the mapping table; and allowing the host to send the converted delete information to the memory system.

According to at least some example embodiments of the inventive concepts, the allowing the host to generate delete information of the first original file when an idle time of the host exceeds a threshold time comprises allowing the host to generate the delete information of the first original file based on a cluster allocation table of the first storage device.

According to at least some example embodiments of the inventive concepts, the allowing the host to generate delete information of the first original file when an idle time of the host exceeds a threshold time comprises allowing the host to generate the delete information of the first original file based on a defragmentation application program interface included in the host.

According to at least some example embodiments of the inventive concepts, the mapping table comprises address mapping information of the first and second storage devices. The allowing the host to generate the converted delete information based on the delete information and the mapping table comprises allowing the host to determine whether the mapping information includes the delete information; and if the determination result indicates that the mapping information includes the delete information, allowing the host to generate the converted delete information corresponding to the delete information.

According to at least some example embodiments of the inventive concepts, the address mapping information is mapping information between an address of the first storage device in which the first original file is stored and an address of the second storage device in which the first copied file is stored.

According to at least some example embodiments of the inventive concepts, the mapping table is stored in the first storage device or the second storage device. During booting of the user system, the host reads the mapping table.

According to at least some example embodiments of the inventive concepts, the first storage device is a hard disk drive and the second storage device is a solid state drive.

According to at least some example embodiments of the inventive concepts, the second storage device is a cache SSD of the memory system.

Another aspect of at least some example embodiments of the inventive concepts is directed to provide an operating method of a user system which includes a host including an operating system and a device driver and a memory system having first and second storage devices. The operating method comprises allowing the operating system to delete a first original file; allowing the operating system to send delete information of the first original file to the device driver; allowing the device driver to compare the delete information and a mapping table; and if the comparison result indicates that the delete information is included in the mapping table, allowing the device driver to send converted delete information corresponding to the delete information to the memory system and the memory system to erase a first copied file of the second storage device corresponding to the converted delete information. The operating system recognizes the first storage device as a main device of the memory system. The mapping table includes mapping information between addresses of the first and second storage devices corresponding to a plurality of files stored in the first and second storage devices.

According to at least some example embodiments of the inventive concepts, the delete information includes address information of the first storage device in which the first original file is stored.

According to at least some example embodiments of the inventive concepts, the converted delete information includes address information of the second storage device in which the original first file is stored.

According to at least some example embodiments of the inventive concepts, the first copied file is a copy of the first original file and is stored in the second storage device.

Another aspect of at least some example embodiments of the inventive concepts is directed to provide an operating method of a user system including a host and a memory system, the host including mapping data, the memory system including a main memory device storing a plurality of main memory units and a secondary storage device storing a plurality of secondary storage units, the method including deleting, at the memory system, a first data unit from among the plurality of main data units; determining, at the host, whether the secondary storage device stores a copied data unit, the copied data unit being a data unit from among the plurality of secondary data units that is a copy of the first data unit, the determining being based on the mapping data; and if the host determines that the secondary storage device stores the second data unit, sending delete information from the host to the memory system, and deleting, at the memory system, the second data unit, based on the delete information.

According to at least some example embodiments of the inventive concepts, the mapping data indicates a relationship between one or more data units from among the plurality of main data units stored at the main storage device and one or more data units from among the plurality of secondary data units stored at the secondary storage device, the secondary storage device being a solid state drive, the main storage device being a different type of memory from the secondary storage device.

According to at least some example embodiments of the inventive concepts, the sending delete information includes sending the delete information such that the delete information identifies an address in the secondary storage device at which the copied data unit is stored.

### BRIEF DESCRIPTION OF THE FIGURES

Example embodiments of the inventive concepts will become more apparent in view of the attached drawings and accompanying detailed description. The example embodiments depicted therein are provided by way of example, not by way of limitation, wherein like reference numerals refer to the same or similar elements. The drawings are not necessarily to scale, emphasis instead being placed upon illustrating aspects of example embodiments of the inventive concepts.

FIG. 1 is a block diagram schematically illustrating a user system according to an embodiment of the inventive concepts;

FIG. 2 is a flow chart schematically illustrating an operation of a host of FIG. 1, according to an embodiment of the inventive concepts;

FIGS. 3 and 4 are diagrams for describing an operation of a user system of FIG. 1, according to an embodiment of the inventive concepts;

FIG. 5 is a block diagram schematically illustrating a user system according to another embodiment of the inventive concept;

FIG. 6 is a flow chart schematically illustrating an operation of a host of FIG. 5, according to an embodiment of the inventive concepts;

FIG. 7 is a diagram for describing step S220 of FIG. 6 in detail, according to an embodiment of the inventive concepts;

FIG. 8 is a diagram schematically illustrating step S220 of FIG. 5, according to another embodiment of the inventive concept;

FIG. 9 is a block diagram schematically illustrating an application of a user system according to an embodiment of the inventive concepts; and

FIG. 10 is a block diagram schematically illustrating another application of a user system according to an embodiment of the inventive concepts.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

It will be understood that, although the terms first, second, third etc. may be used herein to describe various elements, these elements should not be limited by these terms. These terms are used to distinguish one element from another. Thus, a first element discussed below could be termed a second element without departing from the teachings of inventive concepts.

It will be understood that when an element, such as a layer, a region, or a substrate, is referred to as being “on,” “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

The terminology used herein is for the purpose of describing particular example embodiments only and is not intended to be limiting of inventive concepts. As used herein, the singular forms “a,” “an” and “the” are intended to include the plural forms as well, unless the context clearly indicates otherwise. It will be further understood that the terms “comprises”, “comprising”, “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

A user system according to an example embodiment of the inventive concepts operates based on a hybrid memory system or a heterogeneous memory system that includes a HDD and a SSD. The HDD stores original files and the SSD stores copied files. When an original file stored in the HDD is deleted by a host, the host sends converted delete information to a memory system such that a copy file corresponding to the deleted original file is deleted from the SSD. The memory system erases the copy file, stored in the SSD, corresponding to the conversion delete information. Thus, a performance of the user system is improved by erasing copy files, stored in the SSD, corresponding to deleted original files.

FIG. 1 is a block diagram schematically illustrating a user system according to an example embodiment of the inventive concepts. Referring to FIG. 1, a user system 1000 comprises a host 110 and a memory system 120. For example, the user system may be or include a computing system such as a computer, a ultra-mobile personal computer (UMPC), a workstation, a net-book, a personal digital assistance (PDA), a portable computer (PC), a web tablet, a wireless phone, a mobile phone, a smart phone, an e-book, a portable multimedia player (PMP), a portable game console, a navigation device, a black box, a digital camera, a digital multimedia broadcasting (DMB) player, a digital audio recorder, a digital audio player, a digital picture recorder, a digital picture player, a digital video recorder, a digital video player, etc.

The host 110 is configured to access the memory system 120. For example, the host 110 may store data in the memory system 120. The host 110 may read data stored in the memory system 120. The host 110 performs a variety of operations based on data stored in the memory system 120.

The host includes an operating system 111, a file system 112, and a device driver 113. The operating system 111 may control an overall operation of the user system 100. For example, the operating system 111 may include at least one of Windows, Windows CE, Windows mobile, Mac OS, Linux, Unix, VMS, OS/2, solaris, Symbian OS, Palm OS, BSD, DOS, Android, Bada OS, etc.

The file system 112 manages a storage space of the memory system 120 and data stored therein. For example, the operating system 111 accesses data stored in the memory system 120 based on the file system 112. For example, the file system 112 may include FAT (File Allocation Table), FAT32, NTFS (NT File System), HFS (Hierarchical File System), JSF2 (Journaled File System2), XFS, ODS-5 (On-Disk Structure-5), UDF, ZFS, UFS (Unix File System), ext2, ext3, ext4, ReiserFS, Reiser4, ISO 9660, Gnome VFS, BFS, or WinFS. The file system 112 may manage a storage space of a first storage device 121.

The device driver 113 is a program for controlling devices included in the host 110 and devices connected to the host 110. The device driver 113 converts input/output instructions of the operating system 111 into messages corresponding to devices. The device driver 113 may control the memory system 120. For example, the device driver 113 receives a read request on a first file from the operating system 111. The device driver 113 sends a message corresponding to the read request to the memory system 120 in response to the read request.

The memory system 120 may store data processed by the host 110. The memory system 120 may be a storage medium (i.e. a secondary storage, an auxiliary memory unit, etc.) of the user system 100. The memory system 120 includes first and second storage devices 121 and 122. The first storage device 121 is different from the storage device 122. For example, the first storage device 121 may be a hard disk drive (HDD), and the second storage device 122 may be a solid state drive (SSD). According to at least one example embodiment, a storage capacity of the first storage device 121 is larger than that of the second storage device 122; and an operating speed (e.g., data read and write speeds) of the second storage device 122 is faster than that of the first storage device 121.

According to at least some example embodiments of the inventive concepts, the host 110 recognizes the first storage device 121 of the memory system 120 as a main storage device of the memory system 120. In this case, the host 110 collects device information of the first storage device 121. The host 110 accesses the memory system 120 based on the device information. When a first file stored in the first storage device 121 is deleted by the operating system 111, the operating system 111 records a delete mark of the first file in the file system 112. Since the first storage device 121 supports an overwrite function, an additional delete operation of the first storage device 121 is unnecessary.

According to at least some example embodiments of the inventive concepts, the second storage device 122 is used as a cache SSD of the memory system 120. That is, the second storage device 122 may store a file, corresponding to a total number of read requests (e.g., in a reference period of time) that exceeds a threshold value, from among files stored in the first storage device 121. For example, the memory system 120 copies an original file, corresponding to a read request exceeding the threshold value as described above, from among original files stored in the first storage device 121, and stores the copied file in the second storage device 122. When an original file corresponding to a read request received from the host 110 is equal to a copied file stored in the second storage device 122, the memory system 120 sends the copied file stored in the second storage device 122 to the host 110. Thus, it is possible to improve a performance of the user system 100.

The storage device 122 stores metadata 122a. The metadata 122a is information of user data stored in the second storage device 122. Additionally or alternatively, the metadata 122a may include a mapping table having mapping information between a logical address of a file to be stored and a physical address of the second storage device 122.

It is assumed that an original file stored in the first storage device 121 is deleted by the host 110. Since recognizing the first storage device 121 as a main storage device, the host 110 records a delete mark of the first file in the file system 111 without actually deleting an original file. That is, a copied file stored in the second storage device 122 remains as valid data. Since the second storage device 122 recognizes the copied file as valid data, overhead is generated during operations including garbage collection, merge, etc. Thus, an overall performance of the memory system 120 may be lowered.

FIG. 2 is a flow chart schematically illustrating an operation of a host of FIG. 1, according to an embodiment of the inventive concepts. It is assumed that a first storage device 121 stores a first original file FILE1 and a second storage device 122 stores a first copied file FILE1′ being a copy of the first original file FILE1.

Referring to FIG. 2, in step S110, a host 110 deletes the first original file FILE1. For example, an operating system 111 included in the host 110 may recognize the first storage device as a main storage device of a memory system 120. In this case, the file system 112 is configured to manage a storage space of the first storage device 121. When address information of the first original file FILE1 included in the file system 112 is deleted, the operating system 111 recognizes the first original file FILE1 stored in the first storage device 121 to be deleted.

In step S120, the operating system 111 sends delete information DEL to a device driver 113. The delete information DEL includes address information of the first original file FILE 1.

In step 130, the host 110 compares the delete information DEL with information in a mapping table. The mapping table indicates relation between the first storage device 121 and the second storage device 122. For example, the mapping table includes information on relation between an address of the first storage device 121 in which the first original file FILE1 and an address of the second storage device 122 in which the first copied file FILE1′. A device driver 113 determines whether the delete information DEL is included in the mapping table. When the delete information DEL is included in the mapping table, the first file FILE1 may be stored in the first storage device 121 and the first copied file FILE1′ is stored in the second storage device 122. On the other hand, when the delete information DEL is not included in the mapping table, the first file FILE1 is stored only in the first storage device 121.

When the delete information DEL is included in the mapping table according to the comparison result, in step S140, the host 110 transmits converted delete information DEL′ to the memory system 120. The converted delete information DEL′ indicates an address of the second storage device 122 at which the first file FILE1 is stored. According to at least some example embodiments of the inventive concepts, the device driver 113 may send the converted delete information DEL′ to the second storage device 122.

According to at least some example embodiments of the inventive concepts, the memory system 120 sets one or more pages of the second storage device 122, in which the first copied file FILE1′ is stored, to invalid pages in response to the converted delete information DEL′.

Afterwards, the first copied file FILE1′ stored in the second storage device 122 may be erased through operations including garbage collection, merge, etc. For example, the second storage device 122 may include a plurality of memory blocks. A first memory block of the plurality of memory blocks may include the first copied file FILE1′. Also, the first memory block may further include other data in addition to the first copied file FILE1′. The memory system 120 copies data in the first memory block to a free memory block. Afterwards, the memory system 120 erases the first memory block. then, the memory system 120 copies the remaining data of a second memory block other than data of the first copied file FILE1′ to the first memory block. The memory system 120 may erase the first copied file FILE1′ stored in the second storage device 122 based on the above-described process.

According to an embodiment of the inventive concepts, when an operating system deletes a file stored in a memory system, it sends delete information of the deleted file to a device driver. The device driver determines whether a second storage device stores a file corresponding to the delete information, based on the delete information and a mapping table. The device driver transmits converted delete information to the memory system. The memory system erases data stored in the second storage device based on the converted delete information. Thus, since the second storage device does not include unnecessary information, a performance of the memory system is improved.

FIGS. 3 and 4 are diagrams for describing an operation of a user system of FIG. 1, according to an embodiment of the inventive concepts. Referring to FIG. 3, a first storage device 121 includes first to sixth clusters C_{—}1 to C_{—}6, and a second storage device 122 includes first to fifth pages P_{—}1 to P_{—}5. A cluster is a unit of a data storage space of the first storage device 121, and a page is a read/write unit of the second storage device 122. For an easy description, an embodiment of the inventive concepts is described based on cluster and page units. However, the inventive concepts are not limited thereto.

An operating system 111 recognizes the first storage device 121 as a main device of the memory system 120. The operating system 111 accesses a memory system 120 based on a file system 112. The memory system 120 stores first to fourth original files FILE1 to FILE4 in the first storage device 121.

The file system 112 includes address information identifying locations at which the first to fourth original files FILE1 to FILE4 are stored. For example, the file system 112 includes information on a relationship between the first to fourth original files FILE1 to FILE4 and the clusters C_{—}1 to C_{—}6 of the first storage device 121.

The first original file FILE1 is stored in the first cluster C_{—}1. The second original file FILE2 is stored in the second and third clusters C_{—}2 and C_{—}3. The third and fourth original files FILE3 and FILE4 are stored in the fourth and fifth clusters C_{—}4 and C_{—}5, respectively.

The operating system 111 sends a read request I/O Request on the first and second original files FILE1 and FILE2 to a device driver 113. The device driver 113 reads the first and second original files FILE1 and FILE2 stored in the memory system 120 in response to the read request.

The number of read requests on the first and second original files FILE1 and FILE2 may exceed a threshold value. In this case, to improve a performance, the memory system 120 may copy the first and second original files FILE1 and FILE2 to store first and second copied files FILE1′ and FILE2′ in the second storage device 122. At this time, a mapping table 113a indicating relation between the first and second storage devices 121 and 122 is formed. For example, the mapping table 113a includes mapping information between the first cluster C_{—}1 of the first storage device 121, in which the first original file FILE1 is stored, and the second page P_{—}2 of the second storage device 122, in which the first copied file FILE1′ is stored. Also, the mapping table 113a includes mapping information between the second and third cluster C_{—}2 and C_{—}3 of the first storage device 121, in which the second original file FILE2 is stored, and the third and fourth pages P_{—}3 and P_{—}4 of the second storage device 122, in which the second copied file FILE2′ is stored.

Although not shown, the mapping table 113a may be stored, for example, in at least one of the first or second storage device 121 or 122. The host 110 may reads the mapping table 113a together with the file system 112 during an initial booting operation. Also, when an original file stored in the first storage device 121 is copied to the second storage device 122, the mapping table 113a is updated. The host 110 periodically reads the updated mapping table (not shown). When a file is deleted, the host 110 reads the mapping table 113a stored in the first or second storage device 121 or 122.

The device driver 113 determines whether a file corresponding to a read request is stored in the second storage device 122, based on the mapping table 113a. According to the determination result, the device driver 113 controls the memory system 120 such that data stored in the second storage device 122 is read.

According to at least some example embodiments of the inventive concepts, metadata 122a of the second storage device 122 includes mapping information between logical addresses of the first and second copied files FILE1′ and FILE2′ and physical addresses of the second storage device 122. The second storage device 122 operates based on mapping information of the metadata 122a.

Referring to FIG. 4, the operating system 111 deletes the second original file FILE2. The operating system 111 records that the second original file FILE2 is deleted, in the file system 112. Data of the second original file FILE2 stored in the first storage device 121 is invalidated by recording that the second original file FILE2 is deleted, in the file system 112. In other words, new data is overwritten on the second and third clusters C_{—}2 and C_{—}3 of the first storage device 121.

The operating system 111 sends delete information DEL on the second original file FILE2 to the device driver 113. The delete information DEL indicates information of the clusters C_{—}2 and C_{—}3 of the first storage device 121 in which the second original file FILE2 is stored.

The device driver 113 compares the delete information DEL and the mapping table 113a. The mapping table 113a includes mapping information between the first storage device 121 and the second storage device 122. For example, the mapping table 113a includes mapping information between the first cluster C_{—}1 of the first storage device 121, in which the first original file FILE1 is stored, and the second page P_{—}2 of the second storage device 122, in which the first copied file FILE1′ is stored. Also, the mapping table 113a includes mapping information between the second and third cluster C_{—}2 and C_{—}3 of the first storage device 121, in which the second original file FILE2 is stored, and the third and fourth pages P_{—}3 and P_{—}4 of the second storage device 122, in which the second copied file FILE2′ is stored. The device driver 113 determines whether the second copied file FILE2′ being a copy of the second original file FILE2 corresponding to the delete information DEL is stored in the second storage device 122, based on the mapping table 113a and the delete information DEL.

When the second copied file FILE2′ is stored in the second storage device 122, the device driver 113 transfers converted delete information DEL′ to the memory system 120. For example, the second copied file FILE2′ being a copy of the second original file FILE2 deleted by the operating system 111 may be unnecessary data. The device driver 113 sends the converted delete information DEL′ to the memory system 120 such that the memory system 120 invalidates the second copied file FILE2′ stored in the second storage device 122. The converted delete information DEL′ includes information of pages P_{—}3 and P_{—}4 of the second storage device 122 in which the second copied file FILE2′ is stored.

The memory system 120 sets the third and fourth pages P_{—}3 and P_{—}4 of the second storage device 122, in which the second copied file FILE2′ is stored, to invalid pages in response to the converted delete information DEL′. According to at least some example embodiments of the inventive concepts, the memory system 120 erases data stored in pages set to invalid pages through operations including garbage collection, merge, etc. Since the third and fourth pages P_{—}3 and P_{—}4 are erased, other data may be programmed in the third and fourth pages P_{—}3 and P_{—}4.

According to at least some example embodiments of the inventive concepts, metadata 122a of the second storage device 122 stores invalid page information on the third and fourth pages P_{—}3 and P_{—}4. The second storage device 122 erases the third and fourth pages P_{—}3 and P_{—}4, based on the invalid page information of the third and fourth pages P_{—}3 and P_{—}4 stored in the metadata 122a.

If the determination result indicates that the second copied file FILE2′ corresponding to the delete information DEL is not stored in the second storage device 122, the device driver 113 does not perform a separate operation.

According to an embodiment of the inventive concepts, when an original file stored in a first storage device formed of HDD is deleted, a memory system erases a corresponding copied file stored in the second storage device in response to delete information provided from a host. Thus, as programmable pages (or pages each having an erase state) are secured, a performance of the memory system is improved.

FIG. 5 is a block diagram schematically illustrating a user system according to another embodiment of the inventive concepts. Referring to FIG. 5, a user system 200 includes a host 210 and a memory system 220. The host 210 includes an operating system 211, a file system 212 and a device driver 213. The file system 212 includes a cluster allocation table 212a. The device driver 213 includes a mapping table 213a. The memory system 220 includes first and second storage devices 221 and 222. The first storage device 221 includes first to sixth clusters C_{—}1 to C_{—}6. The second storage device 222 includes first to fifth pages P_{—}1 to P_{—}5. The components 210, 211, 212, 213a, 220, 221, and 222 are the same as those described with reference to FIGS. 1 to 43, and a description thereof is thus omitted. Below, a difference between the user system 200 of FIG. 5 and a user system 100 of FIG. 1 is described.

Referring to FIGS. 3 and 5, a second original file FILE2 (refer to FIG. 3) stored in the memory system 200 is deleted by an external device or a predetermined, or alternatively, reference operation. In this case, the operating system 211 records that the second original file FILE2 is deleted, in the file system 212. For example, the operating system 211 records data “0” as a bit corresponding to the second original file FILE2 in the cluster allocation table 212a included in the file system 212. This will be more fully described with reference to FIG. 7.

If the deletion of the second original file FILE2 is recorded in the file system 212, second and third clusters C_{—}2 and C_{—}3 of the first storage device 212 in which the second original file FILE2 is stored are set to an invalid state INVALID.

Afterwards, in the event that an idle time t_{idle} longer than a threshold time tₜₕ elapses, the device driver 213 generates converted delete information DEL′ based on the file system 212. For example, the cluster allocation table 212a may provide data “0” as a bit corresponding to the second original file FILE2. The device driver 213 checks a deletion of the second original file FILE2, based on the cluster allocation table 212a. The device driver 213 acquires address information of the second original file FILE2. The device driver 213 generates the converted delete information DEL′ based on the address information of the second original file FILE2 and the mapping table 213a. For example, the converted delete information DEL′ may include address information of the third and fourth pages P_{—}3 and P_{—}4 of the second storage device 212 that store a second copied filed FILE2′ corresponding to the second original file FILE2.

The memory system 220 sets the third and fourth pages P_{—}3 and P_{—}4, in which the second copied file FILE2′ is stored, to invalid pages in response to the converted delete information DEL′. For example, the memory system 220 erases data stored in pages set to invalid pages through operations including garbage collection, merge, etc. Since the third and fourth pages P_{—}3 and P_{—}4 are erased, other data may be programmed in the third and fourth pages P_{—}3 and P_{—}4.

According to at least some example embodiments of the inventive concepts, metadata 222a of the second storage device 222 stores invalid page information on the third and fourth pages P_{—}3 and P_{—}4. The second storage device 222 erases the third and fourth pages P_{—}3 and P_{—}4, based on the invalid page information of the third and fourth pages P_{—}3 and P_{—}4 stored in the metadata 222a.

According to at least some other example embodiments of the inventive concepts, in the event that an idle time t_{idle} longer than a threshold time tₜₕ exists, the device driver 213 generates the converted delete information DEL′ based on the file system 212 and the mapping table 213a. The device driver 213 sends the converted delete information DEL′ to the memory system 220. The memory system 220 erases a copied file of the second storage device 222 corresponding to the converted delete information DEL′. Thus, a performance of the memory system 220 is improved by securing programmable pages (or, pages each having an erase state) of the second storage device 222.

FIG. 6 is a flow chart schematically illustrating an operation of a host of FIG. 5, according to at least some other example embodiments of the inventive concepts. Referring to FIGS. 5 and 6, in step S210, a host 210 determines whether an idle time t_{idle} is longer than a threshold time tₜₕ. While an operating system 211 of the host 210 responds to an input signal or performs a predetermined, or alternatively, reference operation it may issue a read request to a device driver 213. The idle time t_{idle} is a time during which a memory system 220 does not receive write and read requests from the host 210. When the idle time t_{idle} is shorter than the threshold time tₜₕ, the device driver 213 does not perform an operation for generating converted delete information DEL′. When the idle time t_{idle} is longer than the threshold time tₜₕ, the method proceeds to step S220.

In step S220, the host 210 generates the converted delete information DEL′. For example, the device driver 213 analyzes a file system 212 to collect the converted delete information DEL′. This will be more fully described with reference to FIG. 7. For example, the device driver 213 may generate the converted delete information DEL′ based on a specific API (Application Programming Interface). This will be more fully described with reference to FIG. 8.

In step S230, the host 230 sends the converted delete information DEL′ to the memory system 220. The converted delete information DEL′ includes address information of copied files corresponding to deleted original files.

The memory system 220 sets pages of a second storage device 222 in which copied files corresponding to the converted delete information DEL′ are stored, to invalid pages. Afterwards, the memory system 220 erases data stored in pages set to invalid pages through operations including garbage collection, merge, etc.

According to at least some other example embodiments of the inventive concepts, when the idle time t_{idle} is longer than the threshold time tₜₕ, the device driver 213 collects file deleted information to send it to the memory system 220. The memory system 220 erases a deleted file stored in the second storage device 222 based on the input delete information. Thus, a performance of the memory system 220 is improved by securing programmable pages (or, pages each having an erase state) of the second storage device 222.

FIG. 7 is a diagram for describing step S220 of FIG. 6 in detail, according to an embodiment of the inventive concepts. It is assumed that a file system 212 managing a storage space of a first storage device 221 is NTFS (NT File System). Also, it is assumed that the first storage device 221 stores first to third original files FILE1 to FILE3. However, the inventive concepts are not limited thereto. For example, a device driver 213 may generate converted delete information based on various file systems.

Referring to FIGS. 5 and 7, the first storage device 221 includes first to third original files FILE1 to FILE3. The first and third original files FILE1 and FILE3 are stored in first and fourth clusters C_{—}1 and C_{—}4, respectively. The second original file FILE2 is stored in second and third clusters C_{—}2 and C_{—}3. The first storage device 221 includes a cluster allocation table 212a. The cluster allocation table 212a is a table including bits indicating whether data stored in clusters C_{—}1 to C_n of the first storage device 221 are valid data or deleted data. The cluster allocation table 212a marks bits, corresponding to the first to fourth clusters C_{—}1 to C_{—}4 allocated to the first to third original files FILE1 to FILE3, by data “1”, which indicates that the first to third original files FILE1 to FILE3 stored in the first to fourth clusters C_{—}1 to C_{—}4 are valid data.

Afterwards, an operating system 211 may delete the second original file FILE2. In this case, the cluster allocation table 212a is updated such that bits corresponding to the second and third clusters C_{—}2 and C_{—}3 are marked by bit “0”. In FIG. 7, a reference numeral 212a′ indicates an updated cluster allocation table.

In the event that the idle time t_{idle} is longer than the threshold time tₜₕ, the device driver 213 analyzes the updated cluster allocation table 212a′ to generate converted delete information DEL′. For example, the device driver 213 acquires delete information of the second original file FILE2, based on the updated cluster allocation table 212a′. The device driver 213 generates the converted delete information DEL′ by determining whether a mapping table 213a includes address information of the second original file FILE2. The converted delete information DEL′ includes address information of a second storage device 222 in which a second copied file FILE2′ is stored.

According to at least some other example embodiments of the inventive concepts, when the idle time t_{idle} is longer than the threshold time tₜₕ, the device driver 213 analyzes a file system 212 to collect delete information DEL. The device driver 213 generates the converted delete information DEL′ based on the collected delete information DEL and the mapping table 213a and sends it to the memory system 220. The memory system 220 sets pages of the second storage device 222, in which a copied file corresponding to the converted delete information DEL′ is stored, to invalid pages based on the converted delete information DEL′. Afterwards, the memory system 220 erases data stored in pages set to invalid pages through operations including garbage collection, merge, etc. Thus, a performance of the memory system 220 is improved by securing programmable pages (or, pages each having an erase state) of the second storage device 222.

FIG. 8 is a diagram schematically illustrating step S220 of FIG. 5, according to another embodiment of the inventive concepts. In FIG. 8, there is illustrated a map APIMAP of a disk defragmentation Application Programming Interface (API) of the Windows OS. An API is, for example, an interface for enabling an application program to control a function provided by an operating system or a program language. The API provides an interface for file control, window control, picture processing, text control, etc. The Windows API provides basic services, advanced services, a graphics device interface (GDI), a user interface, a common dialog box library, a common control library, a Windows shell, network services, etc. Another embodiment of the inventive concepts is described using a defragmentation API included in the basic services of the Windows API. However, the inventive concepts are not limited thereto. For example, the device driver 213 may generate delete information based on another API that provides mapping information of a first storage device 221.

Referring to FIGS. 5 and 8, the defragmentation API provides data stored in the first storage device 221 and a map APIMAP of clusters corresponding to the data. The device driver 213 collects information of data stored in the first storage device 221, based on the map APIMAP provided from the defragmentation API. For example, the first storage device 221 stores first to third original files FILE1 to FILE3. In this case, the defragmentation API provides information on a plurality of clusters C_{—}1 to C_{—}4 corresponding to the first to third original files FILE1 to FILE3 stored in the first storage device 221.

Afterwards, if the second original file FILE2 is deleted by an operating system 211, the defragmentation API does not provide information on the second and third clusters C_{—}2 and C_{—}3 corresponding to the second original file FILE2. When an idle time t_{idle} is longer than a threshold time tₜₕ, the device driver 213 analyzes an updated map APIMAP′ provided from the defragmentation API to determine whether the second original file FILE2 is deleted. Afterwards, the device driver 213 generates converted delete information DEL′ by comparing delete information of the second original file FILE2 and a mapping table 213a. The device driver 213 sends converted delete information DEL′ to a memory system 220.

The memory system 220 sets pages of a second storage device 222 in which a second copied file FILE2′ corresponding to the converted delete information DEL′ are stored, to invalid pages. Afterwards, the memory system 220 erases data stored in pages set to invalid pages through operations including garbage collection, merge, etc.

FIG. 9 is a block diagram schematically illustrating an application of a user system according to an embodiment of the inventive concepts. Referring to FIG. 9, a user system 1000 may be one selected from computing systems such as a computer, a ultra-mobile personal computer (UMPC), a workstation, a net-book, a personal digital assistance (PDA), a portable computer (PC), a web tablet, a wireless phone, a mobile phone, a smart phone, an e-book, a portable multimedia player (PMP), a portable game console, a navigation device, a black box, a digital camera, a digital multimedia broadcasting (DMB) player, a digital audio recorder, a digital audio player, a digital picture recorder, a digital picture player, a digital video recorder, a digital video player, and so on.

Referring to FIG. 9, a user system 1000 includes a host 1100 and a memory system 1200. The host 1100 includes a processor 1110, a RAM 1120, and a chipset 1130.

The processor 1110 controls an overall operation of the user system 1000. For example, the processor 1110 controls devices included in the user system 1000 and performs operations including a program instruction decoding operation, etc. An operating system and a device driver described with reference to FIGS. 1 to 8 may be driven by the processor 1110.

The RAM 1120 operates as a main memory device. The RAM 1120 is used as a buffer between the processor 1110 and the memory system 1200. For example, the RAM 1120 is one selected from a group of random access memories such as DRAM (Dynamic Random Access Memory), SDRAM (Synchronous DRAM), SRAM (Static RAM), DDR SDRAM (Double Date Rate SDRAM), DDR2 SDRAM, DDR3 SDRAM, PRAM (Phase-change RAM), MRAM (Magnetic RAM), RRAM (Resistive RAM), and so on.

The chipset 1130 is a device controlling hardware of the user system 1000 according to a control of the processor 1110. For example, the chipset 1130 adjusts a control signal of the memory system 1200 according to a control of the processor 1110.

The memory system 1200 stores data generated by an operation of the host 1100 or data received from an external device. The memory system 1200 includes HDD 1210, SSD 1220, and a controller 1230. The HDD 1210 and the SSD 1220 stores data generated by an operation of the host 1100 or data received from the external device. The HDD 1210 operates based on a magnetic disk. The SSD 1220 operates based on a semiconductor memory device. The controller 1230 controls the DD 1210 and the SSD 1220. According to at least some example embodiments of the inventive concepts, the memory system 1200 is implemented by a module including the HDD 1210, the SSD 1220 and the controller 1230. The host 1100 and the memory system 1200 are interconnected through sockets 1101 and 1201 to exchange signals. According to at least some example embodiments of the inventive concepts, the host 1100 and the memory system 1200 of the user system 1000 are configured to operate based on a method described with reference to FIGS. 1 to 8.

FIG. 10 is a block diagram schematically illustrating another application of a user system according to an embodiment of the inventive concepts. The user system 2000 includes a CPU 2100, a main memory device 2200, a secondary memory device 2300, and a user interface 2400.

The CPU 2100 controls devices included in the user system 2000 and is configured to decode and execute a program instruction. An operating system and a device driver described with reference to FIGS. 1 to 8 are implemented and/or executed by the CPU 2100.

The main memory device 2200 temporarily stores programs to be executed by the CPU 2100 or data to buffer an operating speed between the CPU 2100 and the secondary memory device 2300. The main memory device 2200 may be one selected from a group of random access memories such as DRAM (Dynamic Random Access Memory), SDRAM (Synchronous DRAM), SRAM (Static RAM), DDR SDRAM (Double Date Rate SDRAM), DDR2 SDRAM, DDR3 SDRAM, PRAM (Phase-change RAM), MRAM (Magnetic RAM), RRAM (Resistive RAM), and so on. According to at least some example embodiments of the inventive concepts, the main memory device 2200 may be used as a buffer between the CPU 2100 and the secondary memory device 2300.

The secondary memory device 2300 stores programs or data. According to at least some example embodiments of the inventive concepts, the secondary memory device 2300 may be formed of a plurality of storage devices. For example, the secondary memory device 2300 includes a hybrid memory system formed of HDD and SSD or a heterogeneous memory system. The secondary memory device 2300 is driven according to an operating method of a memory system described with reference to FIGS. 1 to 8.

The user interface 2400 is an interface providing an input/output operation such that a user controls the user system 2000.

A system bus 2500 is connected to the CPU 2100, the main memory device 2200, the secondary memory device 2300, and the user interface 2400, and provides a channel for transferring data.

According to at least some embodiments of the inventive concepts, when a file stored in first and second storage devices is deleted, a device driver receives delete information from an operating system and sends it to a memory system. Or, the device driver generates delete information based on a file system and a specific API and sends the delete information to the memory system. The memory system erases a file of the second storage device corresponding to the delete information. Thus, a performance of the memory system is improved by securing programmable pages (or, pages each having an erase state) of the second storage device.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. An operating method of a user system which includes a host and a memory system, the memory system having first and second storage devices, comprising:
deleting a first original file stored in the first storage device, using the host;
generating, at the host, a comparison result by performing a comparison operation based on first delete information of the first original file and a mapping table;
sending converted delete information from the host to the memory system when the comparison result indicates that a first copied file is stored in the second storage device, the first copied file being a copy of the first original file; and
setting a page of the second storage device, in which the first copied file is stored, to an invalid page based on the converted delete information, using the memory system,
wherein the host recognizes the first storage device as a main device of the memory system, and
wherein the second storage device has an erase-before-write characteristic.

2. The operating method of claim 1, wherein the sending converted delete information includes sending the converted delete information such that the converted delete information includes address information of the second storage device at which the first copied file is stored.

3. The operating method of claim 1, further comprising:
accessing the memory system, using the host, based on a file system of the first storage device.

4. The operating method of claim 1, wherein the sending converted delete information to the memory system comprises:
detecting, at the host, the first delete information of the first original file when an idle time of the host exceeds a threshold time;
generating, at the host, the converted delete information based on the first delete information and the mapping table; and
sending the converted delete information from the host to the memory system.

5. The operating method of claim 4, wherein the generating the converted delete information
generates, at the host, the converted delete information of the first original file based on a cluster allocation table of the first storage device.

6. The operating method of claim 4, wherein the generating the converted delete information
generates, at the host, the first delete information of the first original file based on a defragmentation application program interface included in the host.

7. The operating method of claim 4, wherein the mapping table includes address mapping information of the first and second storage devices, and
wherein the generating the converted delete information based on the first delete information and the mapping table comprises:
determining, at the host, whether the mapping information includes the first delete information; and
generating, at the host, the converted delete information corresponding to the first delete information, if the determination result indicates that the mapping information includes the first delete information.

8. The operating method of claim 7, wherein the address mapping information is mapping information indicating a relationship between an address of the first storage device in which the first original file is stored and an address of the second storage device in which the first copied file is stored.

9. The operating method of claim 1, wherein the first storage device is a hard disk drive and the second storage device is a solid state drive.

10. The operating method of claim 1, wherein the setting a page of the second storage device, in which the first copied file is stored, to an invalid page based on the converted delete information stores, at the memory system, information of the page set to the invalid page in metadata included in the second storage device.

11. The operating method of claim 10, further comprising:
erasing, at the memory system, data stored in the page set to the invalid page based on information of the page set to the invalid page stored in the metadata.

12. An operating method of a user system which includes a host and a memory system, the host including an operating system and a device driver, the memory system having first and second storage devices, the method comprising:
deleting a first original file, using the operating system;
sending first delete information of the first original file from the operating system to the device driver;
comparing, at the device driver, the first delete information and a mapping table; and
if the comparison result indicates that the first delete information is included in the mapping table,
sending converted delete information corresponding to the first delete information from the device driver to the memory system, and
setting, at the memory system, a selected page of the second storage device to an invalid page, the selected page being a page in which a first copied file corresponding to the converted delete information is stored,
wherein the operating system recognizes the first storage device as a main device of the memory system, and
wherein the mapping table includes mapping information indicating a relationship between addresses of the first and second storage devices corresponding to a plurality of files stored in the first and second storage devices.

13. The operating method of claim 12, wherein the first delete information includes address information of the first storage device in which the original first file is stored.

14. The operating method of claim 12, wherein the converted delete information includes address information of the second storage device in which the original first file is stored.

15. The operating method of claim 12, wherein the first copied file is a copy of the first original file and is stored in the second storage device.

16. An operating method of a user system including a host and a memory system, the host including mapping data, the memory system including a main memory device storing a plurality of main memory units and a secondary storage device storing a plurality of secondary storage units, the method comprising:
deleting, at the memory system, a first data unit from among the plurality of main data units;
determining, at the host, whether the secondary storage device stores a copied data unit, the copied data unit being a data unit from among the plurality of secondary data units that is a copy of the first data unit, the determining being based on the mapping data; and
if the host determines that the secondary storage device stores the second data unit,
sending delete information from the host to the memory system, and
deleting, at the memory system, the second data unit, based on the delete information.

17. The method of claim 16, wherein the mapping data indicates a relationship between one or more data units from among the plurality of main data units stored at the main storage device and one or more data units from among the plurality of secondary data units stored at the secondary storage device,
the secondary storage device being a solid state drive, the main storage device being a different type of memory from the secondary storage device.

18. The method of claim 17, wherein the sending delete information includes sending the delete information such that the delete information identifies an address in the secondary storage device at which the copied data unit is stored.
